(19) United States
(12) Patent Application Publication
(10) Pub. No.: US 2007/0297509 A1
(43) Pub. Date: Dec. 27, 2007

(54) Stream encoder and stream decoder

(76) Inventors: Tomoki Mizobuchi, Kyoto (JP); Kosaku Nagahara, Osaka (JP); Tomoaki Kusakabe, Osaka (JP); Osamu Goto, Osaka (JP); Toshio Higuchi, Osaka (JP)

Correspondence Address: MCDERMOTT WILL & EMERY LLP, 600 13TH STREET, NW, WASHINGTON, DC, 20005-3096, US

(21) Appl. No.: 11/812,555

(22) Filed: Jun. 20, 2007

(30) Foreign Application Priority Data
Jun. 21, 2006 (JP) 2006-171332

(51) Int. Cl. H04N 7/12

(52) U.S. Cl. 375/240.12; 375/240.26

(57) ABSTRACT

A stream encoder includes a video encoder for receiving and encoding first and second angle video data, and outputting the results as first and second encoded video data, a first video buffer for storing the first encoded video data, and a second video buffer for storing the second encoded video data. The video encoder includes a motion compensation prediction encoder which can encode two or more frames per frame cycle of the first or second angle video data.

### CROSS REFERENCE TO RELATED APPLICATIONS

This Non-provisional application claims priority under 35 U.S.C. §119(a) on Patent Application No. 2006-171332 filed in Japan on Jun. 21, 2006, the entire contents of which are hereby incorporated by reference.

### BACKGROUND OF THE INVENTION

The present invention relates to a device for generating or decoding stream data of a plurality of pieces of video.

Consumer camcorders have been commonly used. Among other things, DVD (digital versatile disc) camcorders have rapidly become widespread in recent years. A multiangle function is defined in the DVD-Video standard, which is a standard for a DVD recording technique. According to the standard, video is recorded at a plurality of camera angles, and the user can freely select an angle to perform reproduction.

To generate stream data used in the multiangle function, it is necessary to use a specific authoring tool to process a plurality of streams captured separately by the camcorder. Expert knowledge is required for the user to handle the tool.

Therefore, a multichannel recording device has been disclosed in, for example, Japanese Unexamined Patent Application Publication No. 11-103444, in which video, audio and the like input from a plurality of channels are encoded using a plurality of encoders, a VOBU (video object unit) and an ILVU (interleaved unit) are generated from each piece of the encoded stream data, and the ILVUs generated for the channels are interleaved, thereby making it possible to record a plurality of channels of video into a recording medium in real time.

However, in such a recording device, input data needs to be processed in a time-division manner so as to process the data using a single video encoder, so that motion compensation prediction cannot be performed in units of video channels.

Also, timing of switching channels to be encoded is not clear, and it is not guaranteed that encoding of all channels is completed within one frame (or field).

### SUMMARY OF THE INVENTION

An object of the present invention is to provide a stream encoder capable of generating a multiangle stream easily and with low cost.

Specifically, a stream encoder according to the present invention includes a video encoder for receiving and encoding first and second angle video data, and outputting the results as first and second encoded video data, a first video buffer for storing the first encoded video data, and a second video buffer for storing the second encoded video data. The video encoder includes a first angle control section for outputting a first angle control signal for controlling switching to be performed every time when encoding of one frame of the first or second angle video data is completed, a frame selector for selecting and outputting the first or second angle video data in accordance with the first angle control signal, a motion compensation prediction encoder for encoding an output of the frame selector, and outputting the result as the first or second encoded video data, and a buffer selector for outputting the first encoded video data to the first video buffer and the second encoded video data to the second video buffer in accordance with the first angle control signal. The motion compensation prediction encoder includes a first prediction memory, a second prediction memory, a memory selector for outputting reference images for the first and second angle video data to the first and second prediction memories, respectively, in accordance with the first angle control signal, a motion compensation prediction section for performing a motion compensation prediction process using a reference image stored in any one of the first prediction memory and the second prediction memory in accordance with the first angle control signal. The motion compensation prediction encoder can encode two or more frames per frame cycle of the first or second angle video data.

Thereby, the video encoder holds two pieces of angle video data in the respective separate prediction memories, subjects the two pieces of angle video data to motion compensation prediction separately, and outputs the results to the respective separate video buffers. Therefore, two video channels can be encoded using a single video encoder. Also, every time when encoding of one frame of each video is completed, the pieces of video to be processed are switched, thereby making it possible to reliably encode a plurality of channels of video within one frame cycle.

Also, the stream encoder may further include a system encoder for producing and outputting a stream from the first and second encoded video data and encoded audio data common to the first and second encoded video data. Preferably, the system encoder includes a video selector for selecting and outputting the first encoded video data or the second encoded video data from the first video buffer or the second video buffer in accordance with a second angle control signal, a second angle control section for outputting as the second angle control signal a signal for controlling switching to be performed every time when the number of video frames of the encoded video data selected by the video selector reaches a predetermined frame number, an audio packet generating section for generating and outputting an audio packet from the encoded audio data when the first encoded video data is selected in accordance with the second angle control signal, an audio packet holding section for storing the audio packet, and an audio selector for selecting and outputting the audio packet output from the audio packet generating section when the first encoded video data is selected in accordance with the second angle control signal, and the audio packet held by the audio packet holding section when the second encoded video data is selected in accordance with the second angle control signal. The system encoder can encode two or more frames of the first or second encoded video data per frame cycle of the first or second angle video data.

Thereby, every time when a predetermined number of video frames are processed, two pieces of video data are switched. Therefore, a multiangle stream of video data can be produced in real time.

Also, the system encoder may further include a video packet generating section for generating and outputting a video packet header from the received first encoded video data or second encoded video data, and a video packet header holding section for storing the video packet header. Preferably, the video packet generating section generates and outputs the video packet header or reads and outputs the video packet header from the video packet header holding section, in accordance with the second angle control signal.

Thereby, a video packet header is used in common in two video data processes. Therefore, the processing load can be reduced.

Also, preferably, the stream encoder further includes a camera control section for controlling shooting magnification factors of a first camera for outputting the first angle video data and a second camera for shooting in the same direction as that of the first camera and outputting the second angle video data, and outputting shooting magnification factor information indicating the shooting magnification factors of the first and second cameras, and an overlapping video converting section for calculating a portion of video captured by one of the first and second cameras having a smaller shooting magnification factor, the portion overlapping video captured by the other camera, based on the shooting magnification factor information, and converting the overlapping portion into video having a small load in an encoding process.

Thereby, an overlapping portion of two pieces of video is converted into video having a small load in an encoding process. Therefore, the processing load can be reduced.

Also, preferably, the stream encoder further includes a magnification factor detection compensating section for outputting to the camera control section a signal for adjusting the shooting magnification factors of the first and second cameras so that a boundary of the overlapping portion coincides with a boundary of a macroblock for encoding, based on the shooting magnification factor information received from the camera control section.

Thereby, the boundary of an overlapping portion of two pieces of video coincides with the boundary of a macroblock. Therefore, when the overlapping portion is encoded, the processing load can be reduced.

Also, the stream encoder may further include a bit rate adjusting section for obtaining and outputting, as bit rate information, bit rates at which the pieces of video captured by the first and second cameras are encoded, depending on a proportion of the portion overlapping video captured by the other camera to the video captured by one of the first and second cameras having the shooting magnification factor lower than that of the other. Preferably, the video encoder further includes an encoding control section for adjusting the bit rates at which the first and second angle video data are encoded, based on the first angle control signal and the bit rate information.

Thereby, two piece of video can be caused to differ in image quality. Therefore, it is possible to improve the image quality of main video.

Also, preferably, the stream encoder further includes a camera control section for controlling shooting magnification factors of a first camera for outputting the first angle video data and a second camera for shooting in the same direction as that of the first camera and outputting the second angle video data, and outputting shooting magnification factor information indicating the shooting magnification factors of the first and second cameras, and a zoom region information adding section for calculating a portion of video captured by one of the first and second cameras having a smaller shooting magnification factor, the portion overlapping video captured by the other camera, based on the shooting magnification factor information, and combining and outputting a display indicating a range of the video captured by the other camera with the video captured by the one camera having the smaller shooting magnification factor.

Thereby, an overlapping portion of two pieces of video can be displayed in a manner which allows the overlapping portion to be easily recognized.

Also, preferably, the stream encoder further includes a camera control section for controlling shooting magnification factors of a first camera for outputting the first angle video data and a second camera for shooting in the same direction as that of the first camera and outputting the second angle video data, and outputting shooting direction information indicating shooting directions of the first and second cameras, and a camera deviation detecting section for detecting a change in positions and shooting directions of the first and second cameras based on the shooting direction information, and when a change in any of the position and the shooting direction is detected, outputting a signal for controlling to simultaneously display pieces of video of the first and second angle video data.

Thereby, when a change occurs in position or shooting direction of a camera, monitoring video can be automatically switched. Therefore, it is possible to easily recognize the occurrence of a change in position or shooting direction of the camera.

A stream decoder according to the present invention including a data reading section for reading and outputting stream data including first encoded video data, and second encoded video data obtained by shooting in the same direction as a direction in which the first encoded video data is captured and with a magnification factor higher than that of the first encoded video data, a data transferring section for receiving the stream data output by the data reading section, separating the stream data into the first and second encoded video data, and outputting the first and second encoded video data, a first decoder for decoding the first encoded video data and outputting first video data, a second decoder for decoding the second encoded video data and outputting second video data, a resizing process section for converting the second video data into video data having a size of a portion overlapping video of the first video data and outputting the resultant video data, and a combining section for superposing and combining the video after the conversion in the resizing process section with the portion overlapping the video of the first video data, and outputting the resultant video data.

Thereby, it is possible to reproduce a multiangle stream of video data in which an overlapping portion of two pieces of video is converted into data having a small size.

According to the present invention, a plurality of channels of video are processed separately in units of channels by a single encoder. Therefore, it is not necessary to provide an encoder for each channel, thereby making it possible to reduce the cost of the device. In addition, a multiangle stream can be produced by combining a plurality of pieces of video in real time without an editing task.

### BRIEF DESCRIPTION OF THE DRAWINGS

FIG. 1 is a block diagram showing a configuration of a stream encoder according to a first embodiment of the present invention.

FIG. 2 is a diagram showing a configuration of an NV_PCK included in a cell in the DVD video standard.

FIG. 3 is a block diagram showing a configuration of a video encoder 106 of FIG. 1.

FIG. 4 is a block diagram showing a configuration of a system encoder 112 of FIG. 1.

FIG. 5 is a diagram for describing how frames of video captured by cameras 101 and 102 of FIG. 1 are accumulated in video buffers 108 and 109 of FIG. 1.

FIG. 6 is a diagram showing a structure of a video stream produced by the stream encoder of FIG. 1.

FIG. 7 is a block diagram showing a configuration of a system encoder 212 according to a second embodiment of the present invention.

FIG. 8 is a block diagram showing a configuration of a stream encoder according to a third embodiment of the present invention.

FIGS. 9A to 9D are diagrams for describing conversion of an overlapping region of two pieces of video. FIG. 9A is a diagram for describing an input video image of the camera 101 of FIG. 8. FIG. 9B is a diagram for describing an input video image of the camera 102 of FIG. 8. FIG. 9C is a diagram for describing an image which is obtained by converting an overlapping region of the input video of the camera 101 of FIG. 8 and encoding the input video. FIG. 9D is a diagram for describing an image which is obtained by encoding the input video of the camera 102 of FIG. 8.

FIG. 10 is a flowchart showing a procedure of converting an overlapping region of two pieces of video.

FIG. 11 is a diagram for describing a region which is obtained in step S203 of FIG. 10 and in which video data is converted.

FIG. 12 is a block diagram showing a configuration of a stream decoder for reproducing video data which is recorded using the stream encoder of FIG. 8.

FIGS. 13A to 13C are diagrams for describing a process in which video is reproduced in the stream decoder of FIG. 12. FIG. 13A is a diagram for describing video which is captured by the camera 101 of FIG. 8 and is recorded on a DVD 315 of FIG. 12. FIG. 13B is a diagram for describing video which is captured by the camera 102 of FIG. 8 and is recorded on the DVD 315 of FIG. 12. FIG. 13C is a diagram for describing video output to a monitor 322 of FIG. 12.

FIG. 14 is a flowchart showing a procedure of reproducing video in the stream decoder of FIG. 12.

FIG. 15 is a diagram for describing a process of combining pieces of reproduced video in step S306 of FIG. 14.

FIG. 16 is a block diagram showing a configuration of a stream encoder according to a fourth embodiment of the present invention.

FIG. 17 is a flowchart showing a procedure of adjusting the magnification factor of a camera.

FIG. 18 is a diagram for describing a process of adjusting the magnification factor of a camera in step S404 of FIG. 17.

FIG. 19 is a block diagram showing a configuration of a stream encoder according to a fifth embodiment of the present invention.

FIG. 20 is a diagram for describing a process of superposing a frame on wide-angle video.

FIGS. 21A to 21D are diagrams for describing pieces of video which can be switched by a selector of FIG. 19. FIG. 21A is a diagram for describing wide-angle video held by a frame buffer 104 of FIG. 19. FIG. 21B is a diagram for describing zoom video held by a frame buffer 105 of FIG. 19. FIG. 21C is a diagram for describing video which is obtained by a combining section of FIG. 19 superposing zoom video held by the frame buffer 104 and wide-angle video held by the frame buffer 105. FIG. 21D is a diagram for describing video which is obtained by a zoom region information adding section 501 of FIG. 19 superposing the wide-angle video and a frame.

FIG. 22 is a block diagram showing a configuration of a stream encoder according to a sixth embodiment of the present invention.

FIG. 23 is a block diagram showing a configuration of a stream encoder according to a seventh embodiment of the present invention.

FIG. 24 is a block diagram showing a configuration of a video encoder according to the seventh embodiment of the present invention.

### DETAILED DESCRIPTION OF THE PREFERRED EMBODIMENTS

Hereinafter, embodiments of the present invention will be described with reference to the accompanying drawings.

### First Embodiment

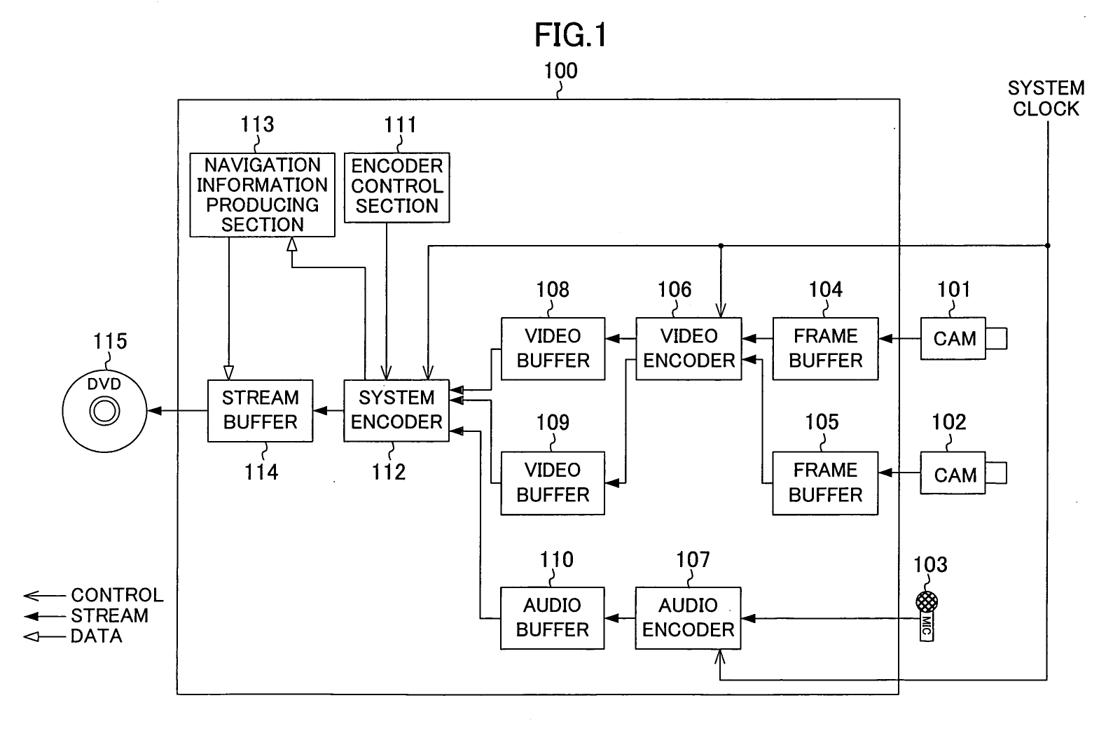

FIG. 1 is a block diagram showing a configuration of a stream encoder according to a first embodiment of the present invention. The stream encoder 100 of FIG. 1 includes frame buffers 104 and 105, a video encoder 106, an audio encoder 107, video buffers 108 and 109, an audio buffer 110, an encoder control section 111, a system encoder 112, a navigation information producing section 113, and a stream buffer 114.

The encoder control section 111 performs controls (e.g., starting and ending recording, and the like) with respect to the system encoder 112. Here, the video encoder 106 and the audio encoder 107 are assumed to be controlled in association with the system encoder 112, and the operations thereof are assumed to be performed in synchronization with the same system clock.

Cameras 101 and 102 each capture a frame of video in synchronization with video capture cycles (frame cycles) Vsync. The captured frame data is stored into the frame buffers 104 and 105. Here, the video captured by the camera 101 is defined as first angle video, and the video captured by the camera 102 is defined as second angle video.

When a request for start of recording is issued by the encoder control section 111, the video encoder 106 encodes frames of data obtained from the frame buffers 104 and 105, alternately, at a rate of one frame per Vsync, and stores the encoded video stream into the video buffers 108 and 109, respectively. The video encoder 106 has a processing ability to encode two or more frames per Vsync. The audio encoder 107 encodes audio input by a microphone 103, and stores the encoded audio stream into the audio buffer 110.

The system encoder 112 multiplexes first and second angle video streams with an audio stream common to the first and second angles, subjects the result to system encoding, and stores the encoded stream into the stream buffer 114, in interleave units. The system encoder 112 has a processing ability to encode two or more frames per Vsync so as to process two pieces of video. Every time when encoding is completed for each angle, the system encoder 112 notifies the navigation information producing section 113 of the completion.

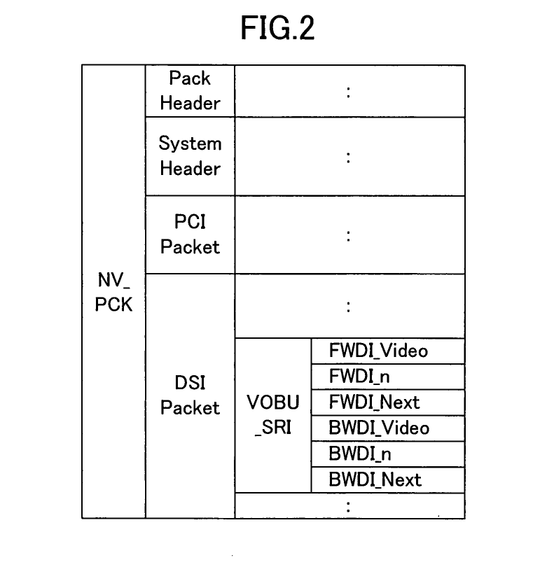

FIG. 2 is a diagram showing a configuration of an NV_PCK (navigation pack) included in a cell in the DVD video standard. VOBU information is information for updating each field of VOBU_SRI (search information) of a DSI_Packet (data search information packet) in the NV_PCK, which is produced by a known technique.

When being notified of the completion of encoding, the navigation information producing section 113 writes information into each field of the VOBU_SRI stored in the stream buffer 114 based on the VOBU information.

The present invention is characterized by holding the VOBU information for each of two angles. Every time when the notice of completion of encoding is received, the two pieces of VOBU information to be used and updated are alternately switched between the two angles, thereby making it possible to maintain the consistency of the navigation information.

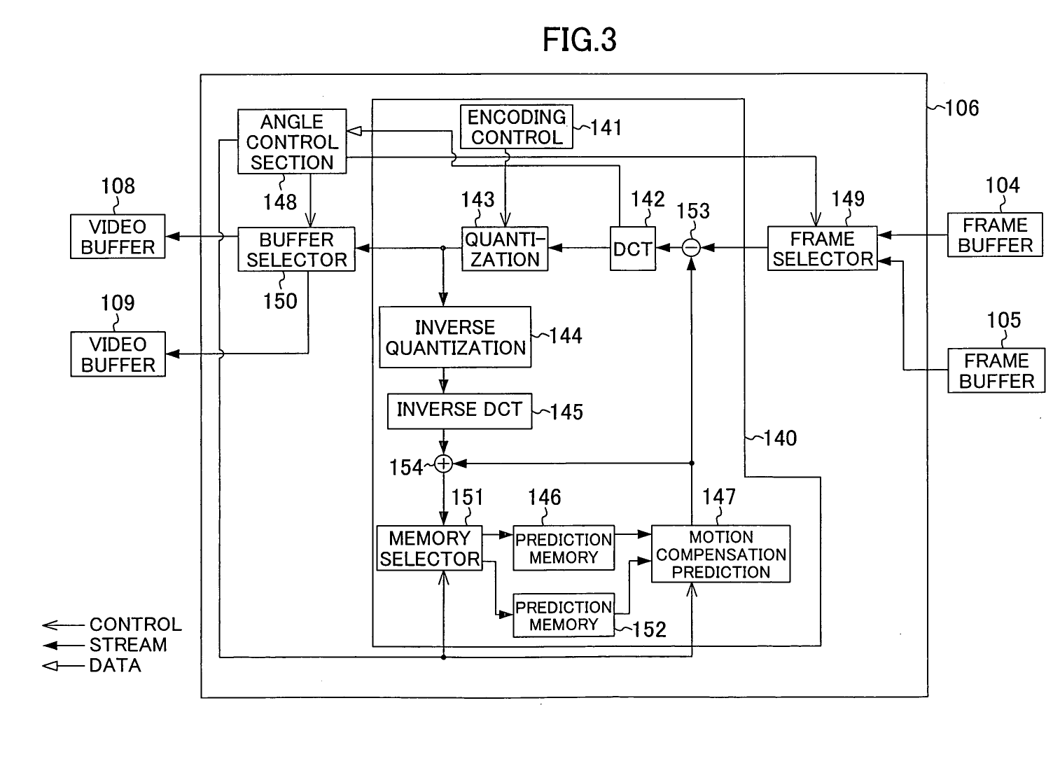

FIG. 3 is a block diagram showing a configuration of the video encoder 106 of FIG. 1. The video encoder 106 includes a motion compensation prediction encoder 140, an angle control section 148, a frame selector 149, and a buffer selector 150. The motion compensation prediction encoder 140 includes an encoding control section 141, a DCT (discrete cosine transform) section 142, a quantization section 143, an inverse quantization section 144, an inverse DCT section 145, prediction memories 146 and 152, a motion compensation prediction section 147, a memory selector 151, a subtractor 153, and an adder 154.

The angle control section 148 outputs a control signal for designating any one of an encoding process for the first angle video and an encoding process for the second angle video, to the frame selector 149, the buffer selector 150, the memory selector 151, and the motion compensation prediction section 147. Immediately after the start of encoding, the angle control section 148 designates the first angle video encoding process, and switches designation between the first angle video and the second angle video every time when being notified of completion of an encoding process of one frame from the DCT section 142.

The frame data of the angles is stored into the frame buffers 104 and 105 in synchronization with the system clock. When the first angle video is designated, the frame selector 149 transfers a frame from the frame buffer 104 to the DCT section 142 in synchronization with the next system clock. When the second angle video is designated, the frame selector 149 immediately transfer a frame from the frame buffer 105 to the DCT section 142. The buffer selector 150 stores compressed video data output from the quantization section 143 into the video buffer 108 when the first angle video is designated and into the video buffer 109 when the second angle video is designated.

The memory selector 151 stores data which is obtained by adding an output of the inverse DCT section 145 and an output of the motion compensation prediction section 147 by the adder 154, into the prediction memory 146 when the first angle video is designated and into the prediction memory 152 when the second angle video is designated. The motion compensation prediction section 147 obtains data which is used as a reference image for motion compensation prediction, from the prediction memory 146 when the first angle video is designated and from the prediction memory 152 when the second angle video is designated. The motion compensation prediction section 147 performs motion compensation prediction using the obtained data.

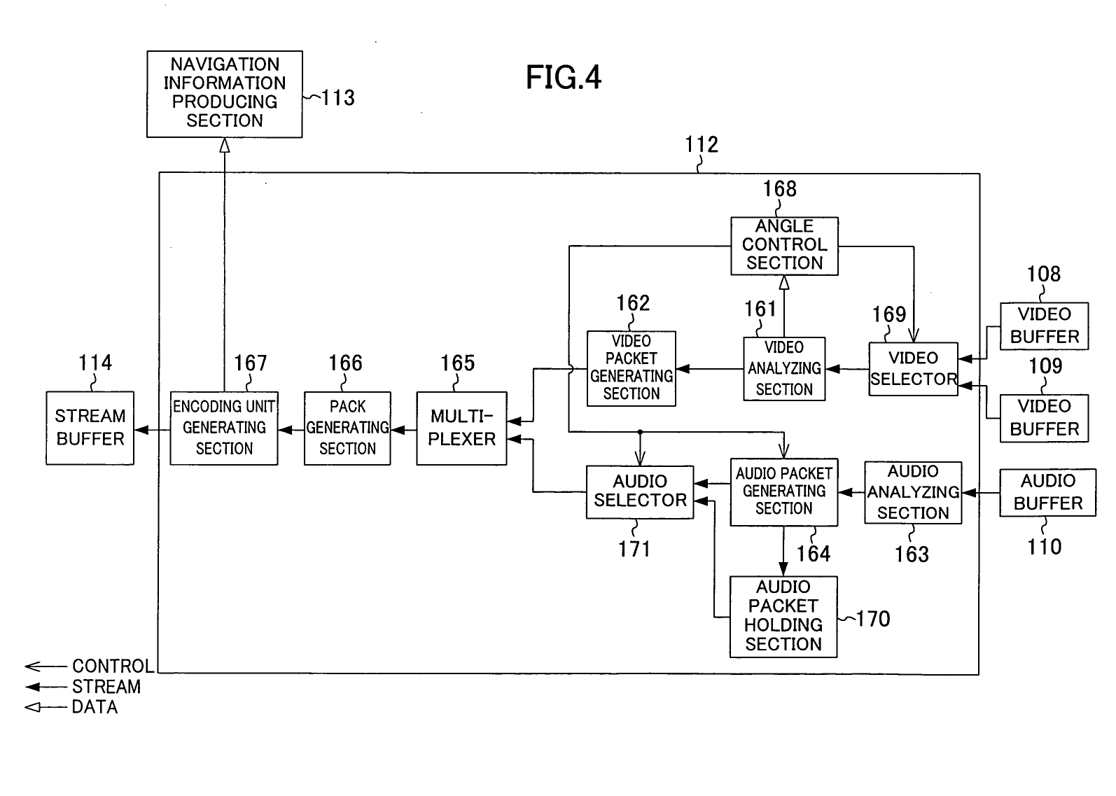

FIG. 4 is a block diagram showing a configuration of the system encoder 112 of FIG. 1. The system encoder 112 includes a video analyzing section 161, a video packet generating section 162, an audio analyzing section 163, an audio packet generating section 164, a multiplexer 165, a pack generating section 166, an encoding unit generating section 167, an angle control section 168, a video selector 169, an audio packet holding section 170, and an audio selector 171.

The angle control section 168 outputs a control signal for designating any of the first angle video encoding process and the second angle video encoding process, to the video analyzing section 161, the video selector 169, the audio packet generating section 164, and the audio selector 171. The angle control section 168 receives detection of a video frame from the video analyzing section 161, and switches the angles every time when the number of the detected frames reaches the interleave unit (encoding unit (e.g., 15 frames)).

The video selector 169 outputs, to the video analyzing section 161, a first video stream stored in the video buffer 108 when the first angle video encoding process is designated, and a second video stream stored in the video buffer 109 when the second angle video encoding process is designated.

The audio packet generating section 164, when the first angle video encoding process is designated, generates a packet from a stream output by the audio analyzing section 163, and transfers the packet to the audio selector 171 and the audio packet holding section 170. The audio packet holding section 170 holds the generated audio packet. On the other hand, when the second angle video encoding process is designated, the audio packet generation is stopped.

The audio selector 171 receives an audio packet output by the audio packet generating section 164 when the first angle video encoding process is designated, and an audio packet held by the audio packet holding section 170 when the second angle video encoding process is designated, and outputs the audio packet to the multiplexer 165.

The system encoder 112 performs a process while switching video streams to be encoded as described above. While one of the video streams is encoded, the other video stream needs to be stored in a buffer.

Hereinafter, buffer sizes of the video buffers 108 and 109 will be described, assuming that the system encoder 112 has a processing ability to encode three frames of video per Vsync.

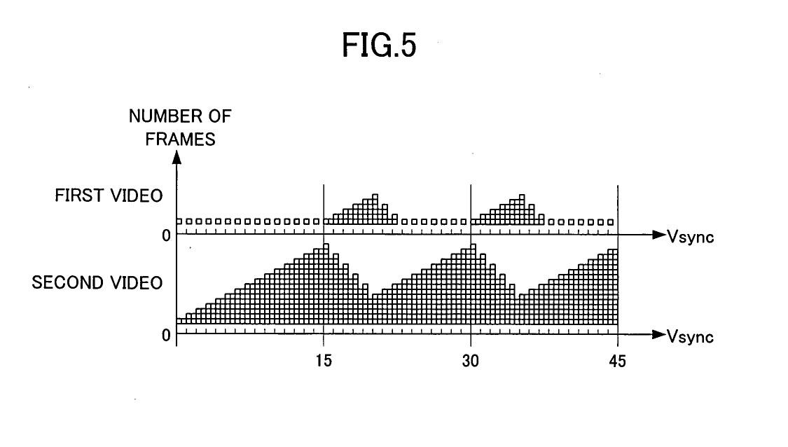

FIG. 5 is a diagram for describing how frames of video captured by the cameras 101 and 102 of FIG. 1 are accumulated in the video buffers 108 and 109 of FIG. 1. As shown in FIG. 5, a frame(s) of each of the first angle video and the second angle video captured by the cameras 101 and 102 is processed and accumulated in units of Vsyncs. The horizontal axis represents Vsync, and one scale indicates one Vsync. The vertical axis represents the number of accumulated frames, and one open square indicates one frame.

After the start of recording, frames of the first angle video generated are processed in units of Vsyncs, while the second angle video is accumulated without being processed. When 15 frames of the first angle video have been processed, the second angle video is then started to be processed.

At this time, frames of the second angle video corresponding to 15 Vsyncs have been accumulated. Next, when 3 frames are encoded per Vsync, the 15 frames of the second angle video which have been accumulated are processed in order of accumulation (earliest first). While the 15 accumulated frames are processed in 5 Vsyncs, new 5 frames are accumulated. When the 15 frames of the second angle video have been processed, the process is switched to processing the first angle video.

At this time, 5 frames of the first angle video have been accumulated. After the accumulated frames are processed, the remaining frames are processed every Vsync. Meanwhile, frames of the second angle video corresponding to 10 Vsyncs are accumulated again, so that frames corresponding to a total of 15 Vsyncs are accumulated. Thereafter, the same process as that for 15th to 29th Vsync of FIG. 5 is repeated.

As a result, it can be understood that the video buffer 108 may have a buffer size which allows 5 frames of stream to be accumulated, and the video buffer 109 may have a buffer size which allows 16 frames of stream to be accumulated.

As described above, the frame buffers for obtaining frames, the video buffers for storage, and the prediction memories to be referenced and updated are switched alternately for the first angle video or the second angle video within one Vsync, so that two pieces of video can be encoded, thereby producing a multiangle stream by a single video encoder.

Also, by guaranteeing that the video encoder encodes two or more frames within one Vsync, video for two angles can be encoded in real time.

Also, by the system encoder processing the first angle video and the second angle video while switching in interleave units, a multiangle stream can be produced by a single video encoder.

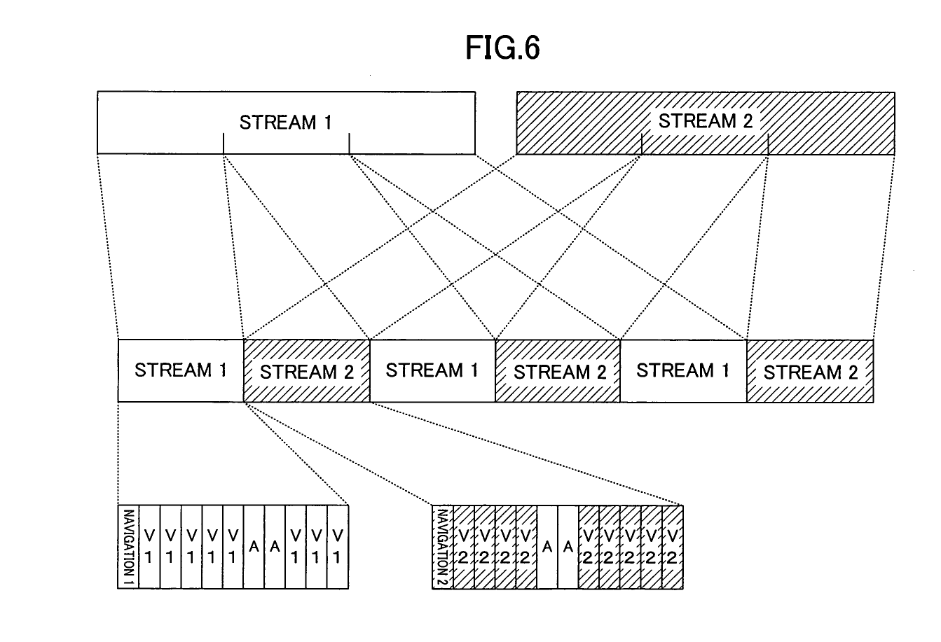

FIG. 6 is a diagram showing a structure of a video stream produced by the stream encoder 100 of FIG. 1. By recording the video stream onto a DVD 115 of FIG. 1, a DVD storing multiangle contents conforming to the DVD-Video standard can be produced.

Thus, according to the present invention, two pieces of video can be encoded using a single video encoder and a single system encoder, thereby making it possible to reduce hardware resources.

### Second Embodiment

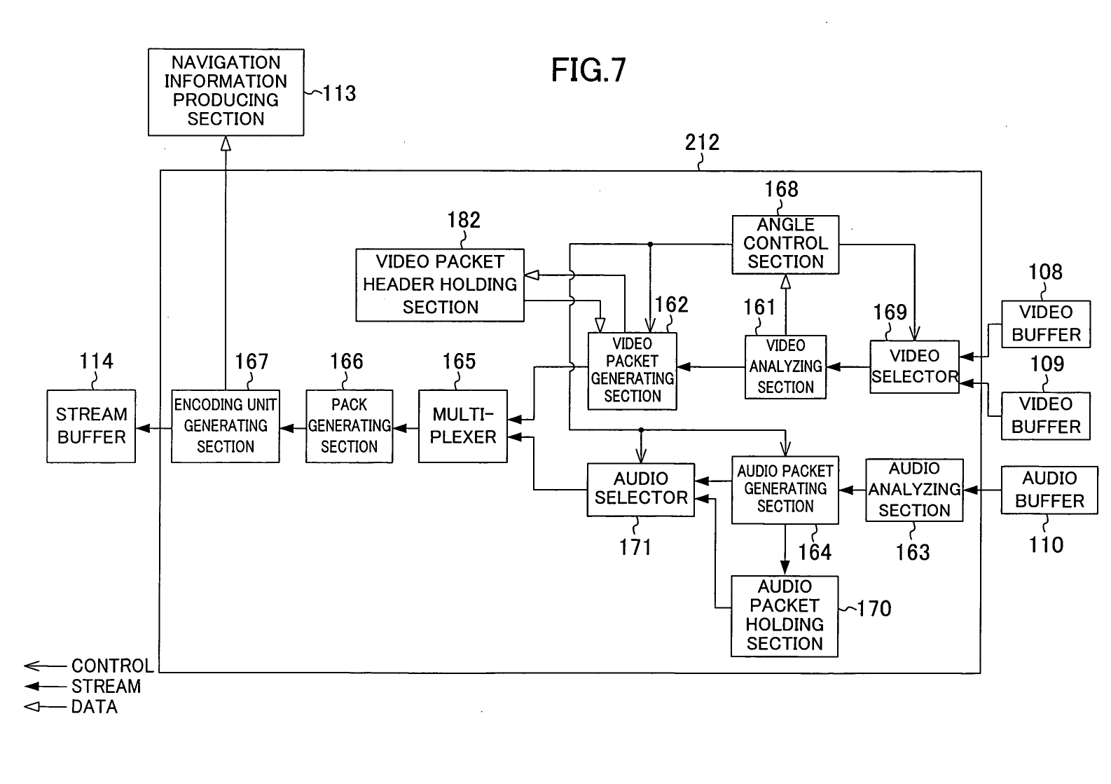

FIG. 7 is a block diagram showing a configuration of a system encoder 212 according to a second embodiment of the present invention. This embodiment is different from the stream encoder 100 of FIG. 1 in that the system encoder 212 is used instead of the system encoder 112. The system encoder 212 of FIG. 7 further includes a video packet header holding section 182 in addition to the configuration of FIG. 4.

The video packet generating section 162, when the first angle video encoding process is designated by the angle control section 168, generates a video packet, and at the same time, outputs a generated packet header to the video packet header holding section 182. The video packet header holding section 182 holds the packet header. The video packet generating section 162, when the second angle video encoding process is designated by the angle control section 168, uses the packet header held by the video packet header holding section 182 without newly generating a packet header.

Also, the video packet header holding section 182 holds a video packet header only in the case of a parameter which does not depend on a stream. For example, in the case of the DVD standard, since the DTS field depends on a stream. Therefore, in this case, the video packet header holding section 182 does not hold a packet header, and the video packet generating section 162 needs to generate a packet header, as in the first angle video, even when generating a video packet for the second angle video.

As described above, the video packet generating section 162 causes the video packet header holding section 182 to hold a video packet generated during encoding of the first angle video, and uses the packet header held by the video packet header holding section 182 during encoding of the second angle video. Therefore, it is possible to remove a packet header generating process during encoding of the second angle video, so that the processing load of the system encoder 212 can be reduced.

### Third Embodiment

A stream encoder according to a third embodiment of the present invention will be hereinafter described. In the stream encoder of the first embodiment, when the two cameras perform shooting in the same direction from the same position, two pieces of video output from the two cameras overlap each other. In the third embodiment, one of the overlapping portions of the two pieces of video is converted into video having no motion before being recorded, thereby reducing the load of an encoding process.

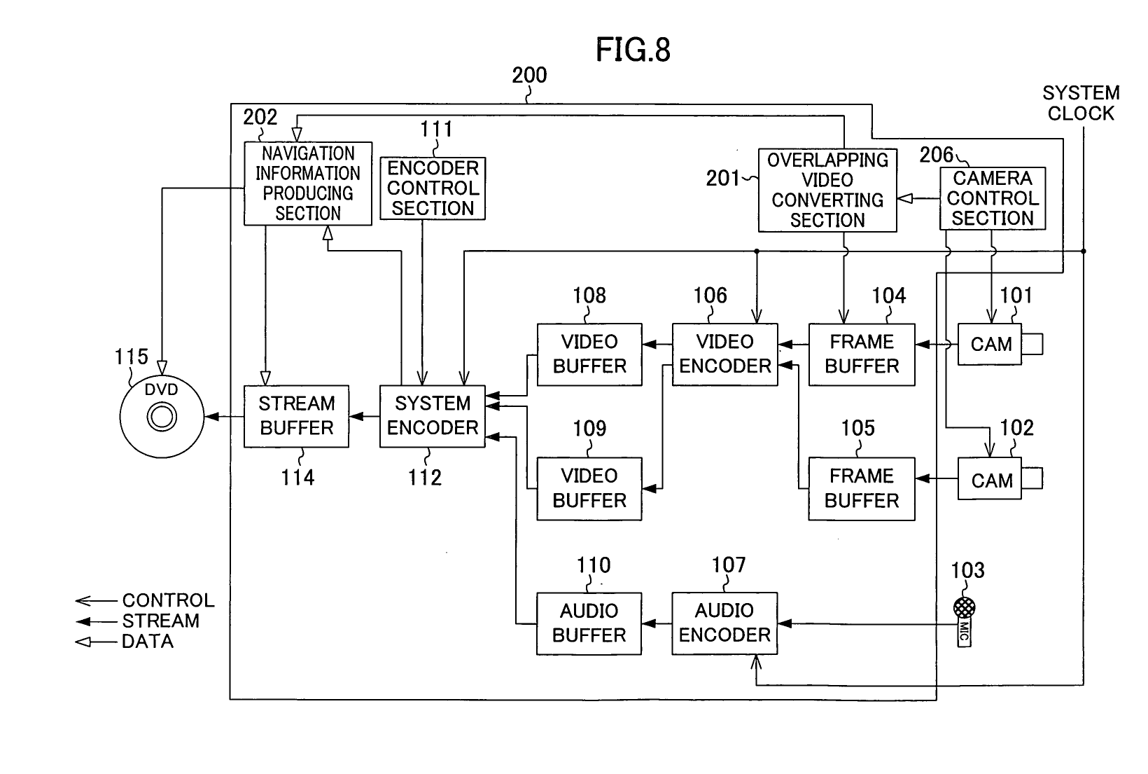

FIG. 8 is a block diagram showing a configuration of the stream encoder of the third embodiment of the present invention. The stream encoder 200 of FIG. 8 is different from the stream encoder 100 of FIG. 1 in which a navigation information producing section 202 is provided instead of the navigation information producing section 113, and an overlapping video converting section 201 and a camera control section 206 are further provided.

Cameras 101 and 102 perform shooting in the same direction from the same position. The camera 101 outputs video of a full view as auxiliary video. The camera 102 outputs, as main video, video having a magnification factor higher than that of the camera 101.

A frame buffer 104 temporarily stores video output by the camera 101. A frame buffer 105 temporarily stores video output by the camera 102. The camera control section 206 controls the cameras 101 and 102 and outputs magnification factors of the cameras 101 and 102 as magnification factor information.

The overlapping video converting section 201 detects an overlapping portion of the pieces of video held by the frame buffer 104 and the frame buffer 105 based on the magnification factor information about the cameras 101 and 102 obtained from the camera control section 206, and converts the video held by the frame buffer 104 into video in which no motion is present in the overlapping portion. The pieces of video held by the frame buffers 104 and 105 are encoded by the video encoder 106.

The navigation information producing section 202 produces navigation information, and in addition, receives the magnification factor information about the two cameras from the overlapping video converting section 201, and also writes the magnification factor information onto a DVD 115 when NV_PCK is written. The other blocks of FIG. 8 perform processes similar to those of the first embodiment.

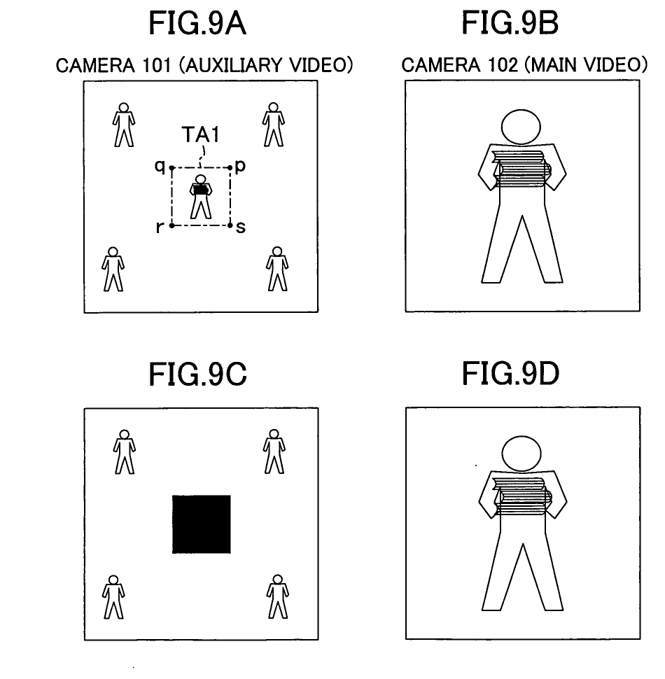

FIGS. 9A to 9D are diagrams for describing conversion of an overlapping region of the two pieces of video. FIG. 9A is a diagram for describing an input video image of the camera 101 of FIG. 8. FIG. 9B is a diagram for describing an input video image of the camera 102 of FIG. 8. FIG. 9C is a diagram for describing an image which is obtained by converting the overlapping region of the input video of the camera 101 of FIG. 8 and encoding the input video. FIG. 9D is a diagram for describing an image which is obtained by encoding the input video of the camera 102 of FIG. 8.

It is assumed that auxiliary video is input in FIG. 9A while main video is input in FIG. 9B. A region TA1 indicated with a dashed line in FIG. 9A is the same video as that which is obtained by shrinking the video of FIG. 9B. The overlapping video converting section 201 converts the region TA1 indicated with the dashed line in FIG. 9A into a single color (e.g., black) as shown in FIG. 9C in the frame buffer 104. When video is reproduced, the video of FIG. 9D which is obtained by directly encoding FIG. 9B and the magnification factor information when the video was captured can return the black converted portion of FIG. 9C to the original states.

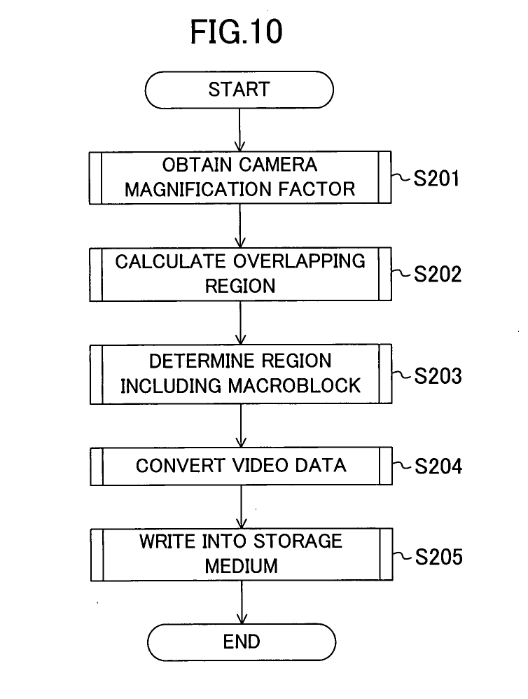

FIG. 10 is a flowchart showing a procedure of converting an overlapping region of two pieces of video. The overlapping video converting section 201 obtains the magnification factor information about the cameras 101 and 102 (step S201). For example, the camera magnification factor is obtained by referencing a register, a variable or the like which is provided within a control module of the camera and in which camera magnification factors are held.

The overlapping video converting section 201 calculates an overlapping region based on a relationship between the magnification factors of the cameras 101 and 102 (step S202). Assuming that the center of the video is located at center coordinates (0, 0) on an x-y plane, and the coordinates of points p, q, r and s of the overlapping region of FIG. 9A are represented by p(px, py), q(qx, qy), r(rx, ry) and s(sx, sy), the overlapping region is represented by:

px=(B/2)*(X1/X2)

py=(A/2)*(X1/X2)

qx=−(B/2)*(X1/X2)

qy=(A/2)*(X1/X2)

rx=−(B/2)*(X1/X2)

ry=−(A/2)*(X1/X2)

sx=(B/2)*(X1/X2)

sy=−(A/2)*(X1/X2)

where A represents the length of each piece of video, B represents the width of each piece of video, X1 represents the magnification factor of the camera 101, and X2 represents the magnification factor of the camera 102.

Next, the overlapping video converting section 201 obtains a region of video data which is to be converted (step S203). In this case, video data is converted in units of macroblocks.

The overlapping video converting section 201 converts video data of the region determined in step S203 (step S204). For example, luminance information, color-difference information or the like about the video data is converted into black-color information. By this process, the load of processing the overlapping region can be reduced when video is encoded.

Next, the navigation information producing section 202 receives the magnification factor information about the two cameras from the overlapping video converting section 201, and writes the magnification factor information into a region of a recording medium into which data can be freely written (e.g., in the case of a DVD, a vender unique region) (step S205).

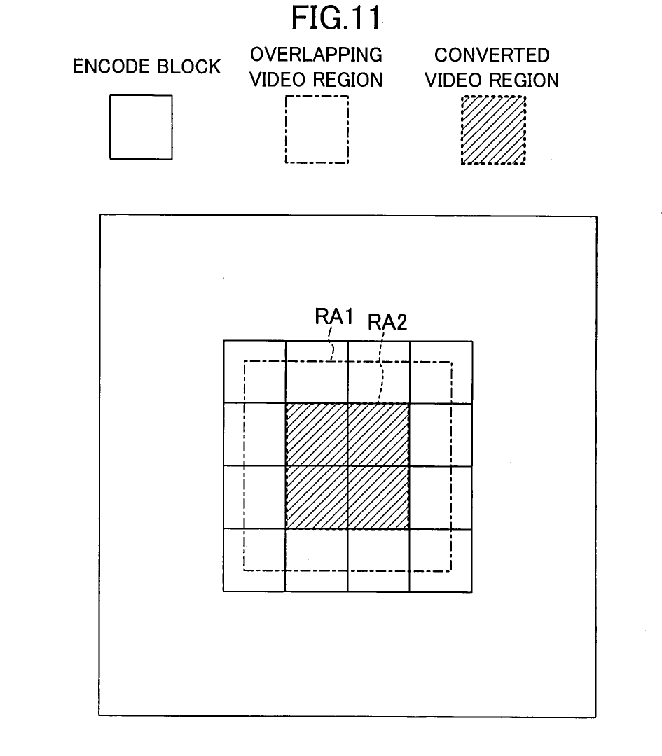

FIG. 11 is a diagram for describing the region which is obtained in step S203 of FIG. 10 and in which video data is converted. RA1 indicates a region in which two pieces of video captured by the two cameras overlap each other. RA2 indicates a region which is obtained by dividing the overlapping region into macroblocks.

Next, a method of calculating the region in which video data is converted will be described. For example, assuming that the lengthwise and widthwise sizes of a macroblock have known values (C, D) and the number of macroblocks is even, the number of macroblocks in the conversion region is:

((B/2*(X1/X2))/D) in x-axis, positive direction;

((B/2*(X1/X2))/D) in x axis, negative direction;

((A/2*(X1/X2))/C) in y-axis, positive direction; and

((A/2*(X1/X2))/C) in y-axis, negative direction.

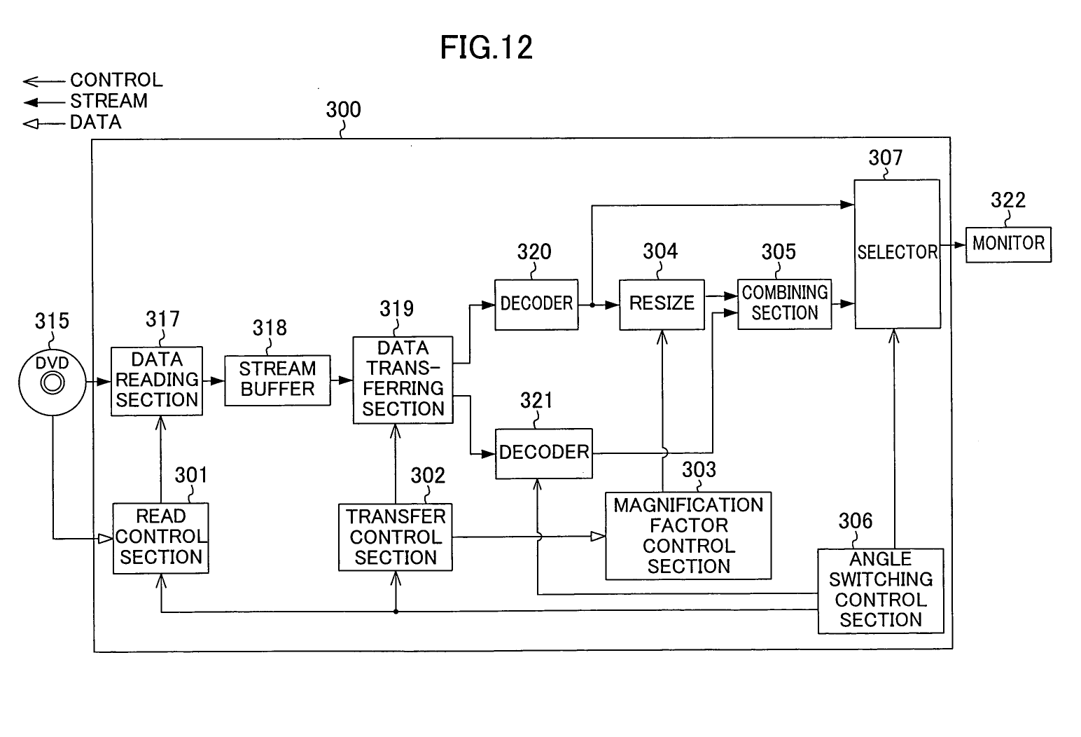

FIG. 12 is a block diagram showing a configuration of a stream decoder for reproducing video data which is recorded using the stream encoder 200 of FIG. 8. The stream decoder 300 of FIG. 12 includes a read control section 301, a transfer control section 302, a magnification factor control section 303, a resizing section 304, a combining section 305, an angle switch control section 306, a selector 307, a data reading section 317, a stream buffer 318, a data transferring section 319, a decoder 320, and a decoder 321.

The read control section 301, when angle switching is valid, controls the data reading section 317 to read out data for both the angles from a DVD 315. The data reading section 317 reads out stream data to be reproduced from the DVD 315 in accordance with the control request from the read control section 301. The stream buffer 318 temporarily holds the stream data read out by the data reading section 317.

The transfer control section 302 outputs a transfer request to the data transferring section 319, depending on a transfer condition. The data transferring section 319 transfers stream data from the stream buffer 318 to the decoder 320 or the decoder 321 in accordance with the request from the transfer control section 302. The decoder 320 decodes stream data during reproduction. The decoder 321, when receiving an angle switching request, decodes stream data of an angle which is requested by the angle switching request.

The magnification factor control section 303 performs a magnification factor switching control with respect to the resizing section 304. The resizing section 304 converts an image size input from the decoder 320. The combining section 305 combines and outputs two or more images as a single image.

For example, the angle switch control section 306 determines the presence or absence of angle switching by referencing a variable, such as an application module or the like, and outputs an angle switching request to each block. The selector 307 selects a piece of video in accordance with the angle switching request received from the angle switch control section 306, and outputs the selected video to a monitor 322.

A multiangle output image when a multiangle stream is reproduced using the thus-configured stream decoder will be described.

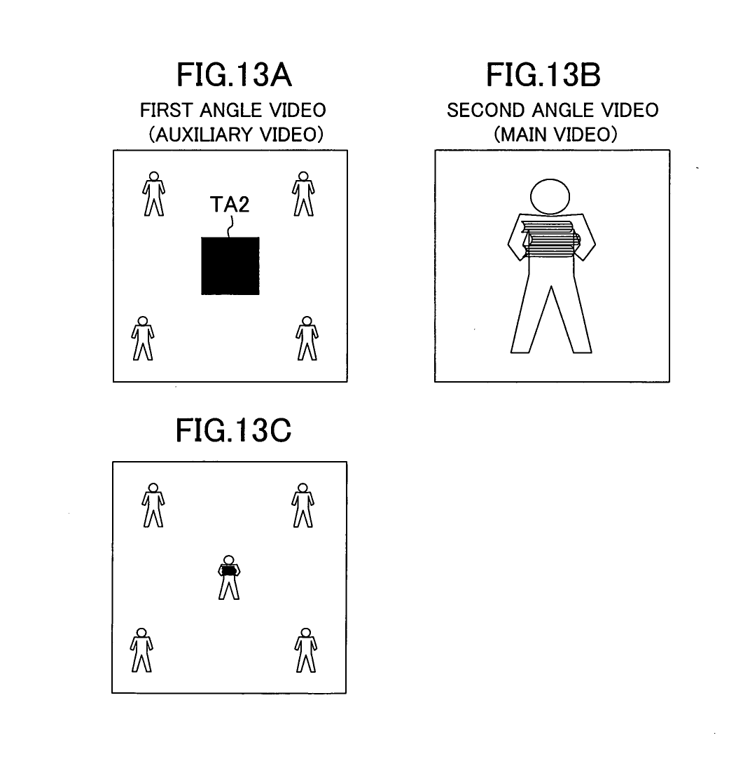

FIGS. 13A to 13C are diagrams for describing a process in which video is reproduced in the stream decoder 300 of FIG. 12. FIG. 13A is a diagram for describing video which is captured by the camera 101 of FIG. 8 and is recorded on the DVD 315 of FIG. 12. FIG. 13B is a diagram for describing video which is captured by the camera 102 of FIG. 8 and is recorded on the DVD 315 of FIG. 12. FIG. 13C is a diagram for describing video output to the monitor 322 of FIG. 12.

The stream decoder 300 of FIG. 12, when outputting the video of FIG. 13A which is auxiliary video, combines the main video of FIG. 13B into a region TA2 in FIG. 13A which has been converted into a black color, and outputs the result.

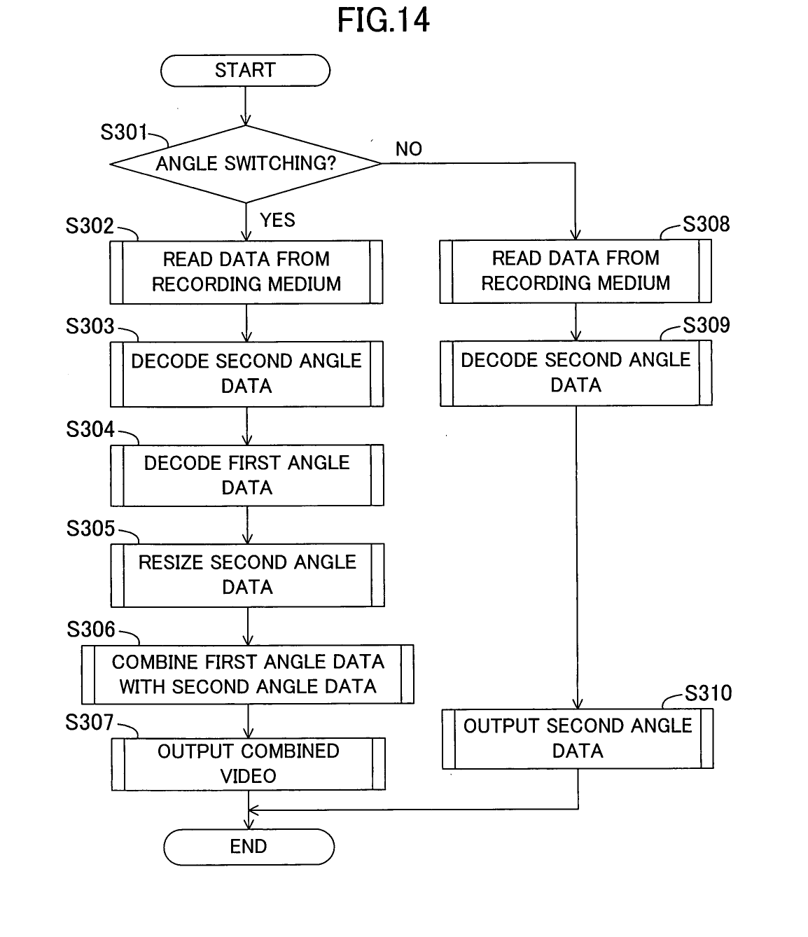

FIG. 14 is a flowchart showing a procedure of reproducing video in the stream decoder 300 of FIG. 12. When the procedure is started, the angle switch control section 306 determines the presence or absence of angle switching, and goes to step S302 when angle switching is valid and to step S308 when angle switching is invalid (step S301).

Next, the read control section 301 requests the data reading section 317 to read out data of both the first angle video and the second angle video into the stream buffer 318, so that the data reading section 317 reads stream data from the DVD 315 (step S302).

The transfer control section 302 transmits a transfer request to the data transferring section 319, so that stream data of the second angle video is transferred to the decoder 320, in which the stream data is decoded (step S303).

Following this, the transfer control section 302 transmits a transfer request to the data transferring section 319, so that stream data of the first angle video is transferred to the decoder 321, in which the stream data is decoded (step S304). A decoder which is a transfer destination in step S304 is different from a transfer destination in step S303. Therefore, for example, when transfer is performed by DMA (direct memory access), a channel which is different from that in step S303 can be used to perform transfer with the same timing as that in step S303. Also, it is assumed that the decoder 320 and the decoder 321 are operated in synchronization with each other, so that the decoder 320 and the decoder 321 can output video with the same timing and the same PTS (presentation time stamp).

Next, the magnification factor control section 303 issues a resizing request to the resizing section 304 based on magnification factor information read out from the DVD 315 (step S305). A magnification factor for resizing is represented by:

Q=X2/X1

where Q represents the value of the magnification factor for resizing, X1 represents the magnification factor of the camera 101 during recording, and X2 represents the magnification factor of the camera 102 during recording.

Next, the combining section 305 superposes and combines the first angle video and the second angle video, and outputs the result to the selector 307 (step S306).

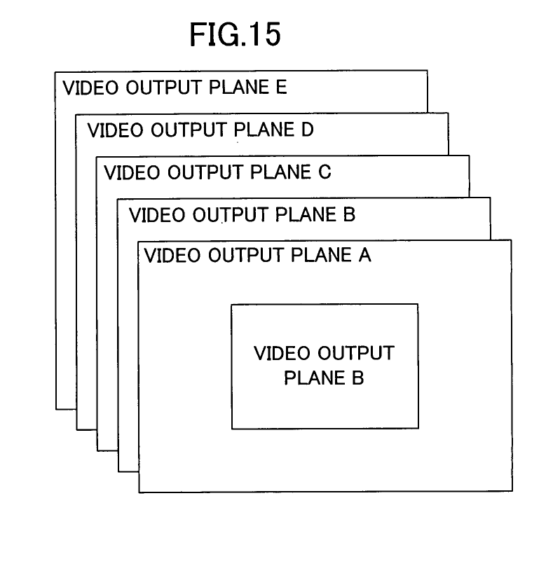

FIG. 15 is a diagram for describing a process of combining pieces of reproduced video in step S306 of FIG. 14. For example, when there are video output planes A to E as shown in FIG. 15, the combining section 305 assigns and outputs the first angle video to the video output plane A and the second angle video to the video output plane B, thereby combining the first angle video and the second angle video.

The angle switch control section 306 controls the selector 307 to output the video obtained by combining the first angle video and the second angle video (step S307).

A process when it is determined in step S301 that angle switching is invalid will be described. The read control section 301 requests the data reading section 317 to read out data of the second angle video into the stream buffer 318, so that the data reading section 317 reads stream data from the DVD 315 (step S308).

The transfer control section 302 requests the data transferring section 319 to transfer stream data from the stream buffer 318, so that the data transferring section 319 transfers stream data from the stream buffer 318 to the decoder 320, in which the stream data is decoded and output to the selector 307 (step S309).

The angle switch control section 306 controls the selector 307 to output video (step S310).

As described above, according to the third embodiment, the overlapping video converting section 201 of FIG. 8 determines an overlapping portion of pieces of input video of the two cameras based on a relationship between the two cameras, converts video information (luminance information, color-difference information or the like) about one of the two pieces of input video into black-color data which has no motion, thereby reducing the load of the encoding process of the stream encoder 200.

### Fourth Embodiment

A stream combining method and a stream encoder according to a fourth embodiment of the present invention will be hereinafter described.

In the overlapping region converting process described in step S203 of FIG. 10, encoding of an overlapping region extending over macroblocks does not contribute to a reduction in load. In the fourth embodiment, the magnification factor of a camera is adjusted so that an overlapping region does not extend over macroblocks, so that the load of a process during encoding can be further reduced than in the third embodiment.

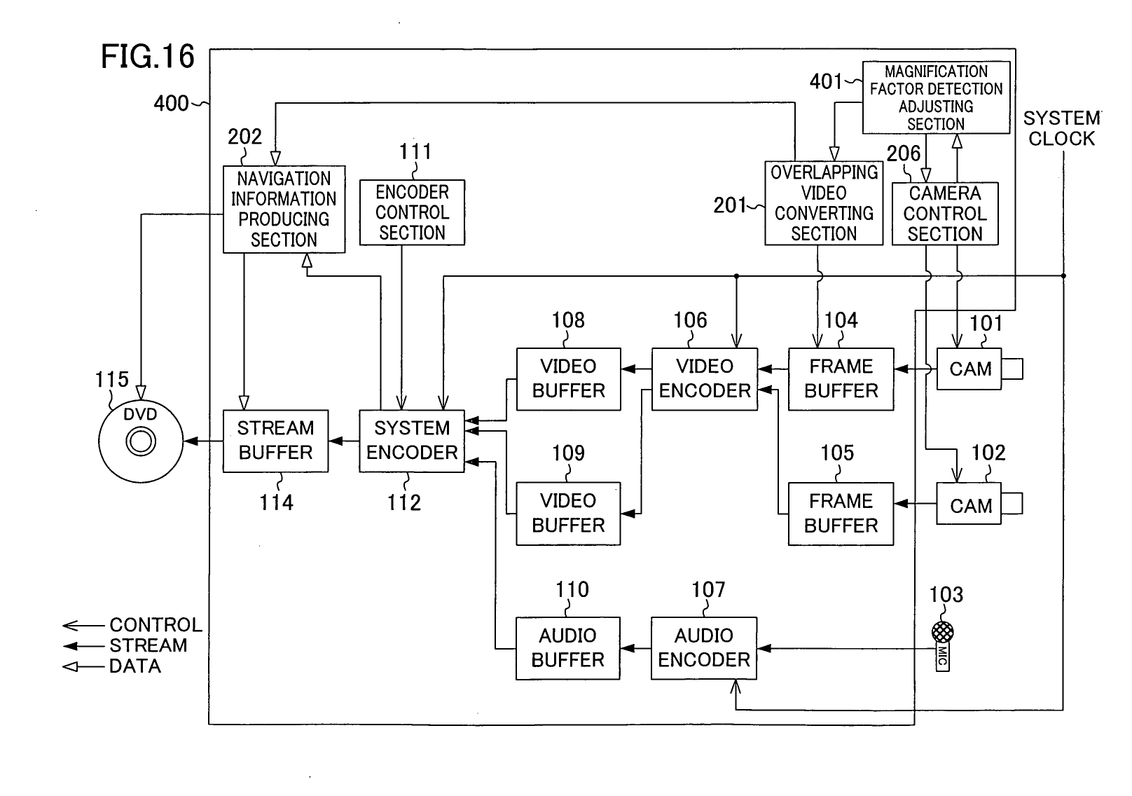

FIG. 16 is a block diagram showing a configuration of a stream encoder according to a fourth embodiment of the present invention. The stream encoder 400 of FIG. 16 is different from the stream encoder 200 of FIG. 8 in that a magnification factor detection adjusting section 401 is further provided.

The camera control section 206 transfers magnification factor information to the magnification factor detection adjusting section 401 with timing of changing the magnification factor of the camera 101 or the camera 102. The magnification factor detection adjusting section 401 calculates magnification factor information in which the size of the overlapping region becomes an integral multiple of the macroblock size, based on a relationship between the magnification factors of the cameras 101 and 102, and outputs the magnification factor information to the camera control section 206. The camera control section 206 adjusts the magnification factor of the camera 101 based on the magnification factor information received from the magnification factor detection adjusting section 401.

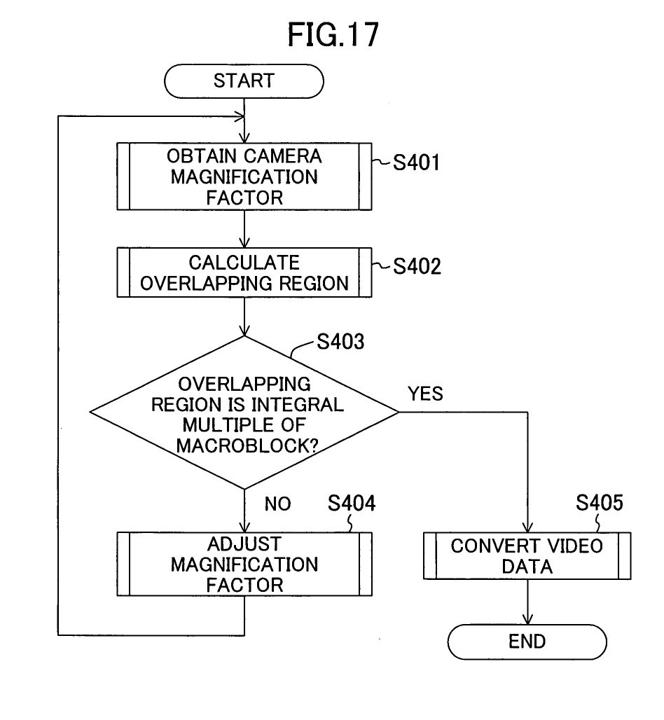

FIG. 17 is a flowchart showing a procedure of adjusting the magnification factor of a camera. The camera control section 206 obtains magnification factor information from the cameras 101 and 102, and outputs the magnification factor information to the magnification factor detection adjusting section 401 (step S401).

The magnification factor detection adjusting section 401 calculates an overlapping region of pieces of video of the cameras 101 and 102 (step S402). The overlapping region is calculated in a manner similar to that of the stream encoder 200 of the third embodiment. The magnification factor detection adjusting section 401 determines whether or not the size of the overlapping region is an integral multiple of the macroblock size (step S403).

Next, the determination in step S403 will be described. The size S of the overlapping region is represented by:

S=[{A*(X1/X2)}*{B*(X1/X2)}]

where A represents the length of video, B represents the width of video, X1 represents the magnification factor of the camera 101, and X2 represents the magnification factor of the camera 102.

Also, the macroblock size M is represented by:

M=C*D

where C represents the length of a macroblock and D represents the width of a macroblock.

In step S403, it is determined whether or not a value obtained by dividing the overlapping region size S by the macroblock size M is an integer.

The magnification factor of the camera 101 is adjusted, and the flow returns to the process of step S401 (step S404). The magnification factor is adjusted as follows. The ratio of the length of the camera to the length of the overlapping region is equal to the ratio of the product of the changed magnification factor by the length of the camera to the length of the black region which is an integral multiple of a macroblock. Therefore, the magnification factor is represented by:

X1=X2*E/A

where E represents the length of the black region which is an integral multiple of a macroblock, and the other variables are the same as those used in calculation in step S403.

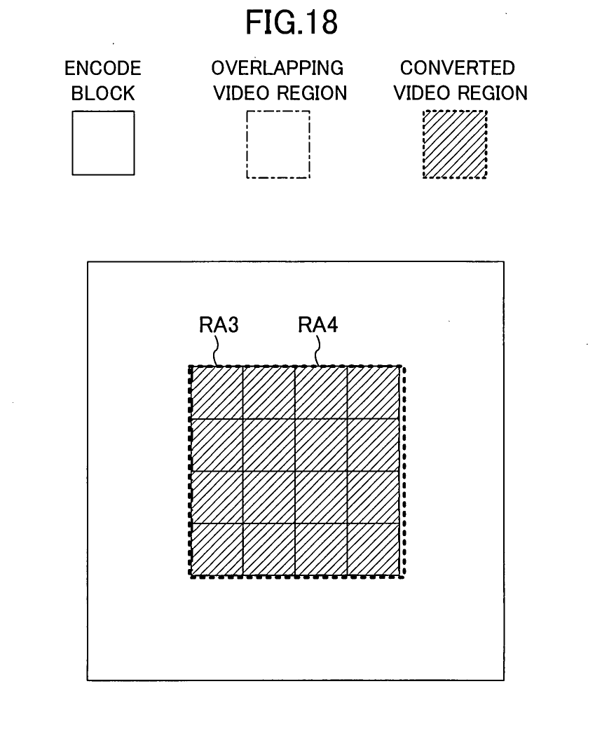

FIG. 18 is a diagram for describing a process of adjusting the magnification factor of a camera in step S404 of FIG. 17. RA3 indicates an overlapping region of pieces of video captured by the two cameras. RA4 indicates a region which is obtained by dividing the overlapping region into macroblocks. In step S404, by setting the overlapping region size to be an integral multiple of the macroblock size, RA3 and RA4 match each other as shown in FIG. 18.

The magnification factor detection adjusting section 401 transfers the thus-determined magnification factor information about the cameras 101 and 102 to the overlapping video converting section 201 (step S405).

As described above, in the fourth embodiment, the magnification factor detection adjusting section 401 calculates the overlapping region based on a relationship between the magnification factors of the two cameras obtained from the camera control section 206, and feeds magnification factor information back to the camera control section 206 in units of macroblocks, thereby making it possible to remove useless conversion of an overlapping region of pieces of video of the two cameras in the third embodiment, and reduce the processing load during encoding.

### Fifth Embodiment

In the fifth embodiment, a monitoring method during shooting in the third embodiment will be described. As a method of displaying pieces of video captured by two cameras on a single monitor, generally, video of only one camera is displayed, or the pieces of video of the two cameras are simultaneously displayed on a single screen. In the fifth embodiment, two cameras are placed at the same position, shooting in the same direction. When only the magnification factors are different from each other, a zoom-shot region in wide-angle-shot video is indicated with a frame, thereby making it possible to easily confirm a relative relationship between wide-angle video and zoom video on a single screen.

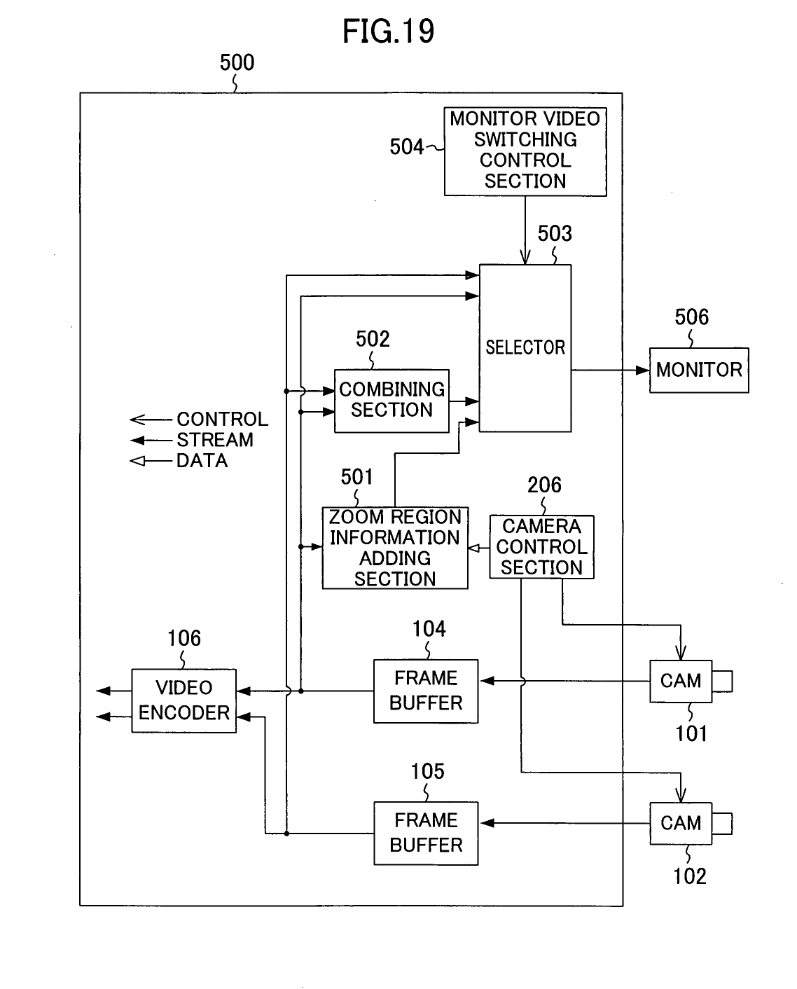

FIG. 19 is a block diagram showing a configuration of a stream encoder according to a fifth embodiment of the present invention. The stream encoder 500 of FIG. 19 is different from the stream encoder 200 of FIG. 8 in that a zoom region information adding section 501 is provided instead of the overlapping video converting section 201, and a combining section 502, a selector 503, and a monitor video switching control section 504 are further provided. In FIG. 19, the audio encoder 107, the video buffers 108 and 109, the audio buffer 110, the encoder control section 111, the system encoder 112, the stream buffer 114, and the navigation information producing section 202 are not shown. The cameras 101 and 102 have the same position and the same shooting direction, and are different only in the magnification factor.

Hereinafter, an operation of the whole stream encoder 500 will be described with reference to FIG. 19. In this embodiment, the camera 101 captures wide-angle video, while the camera 102 capture zoom video.

Wide-angle video data input from the camera 101 is stored into the frame buffer 104. Similarly, zoom video data input from the camera 102 is stored into the frame buffer 105.

The camera control section 206 performs a magnification factor control for the camera 101 and the camera 102. The camera 101 captures wide-angle video, while the camera 102 captures zoom video. Therefore, a relationship in magnification factor between the camera 101 and the camera 102 satisfies the following condition:

(the magnification factor of the camera 101)≦(the magnification factor of the camera 102).

When it is requested that the magnification factor of the camera 101 becomes larger than the magnification factor of the camera 102, the magnification factor of the camera 102 is also increased so as to satisfy the above-described condition. When it is requested that the magnification factor of the camera 102 becomes smaller than the magnification factor of the camera 101, the magnification factor of the camera 101 is also decreased so as to satisfy the above-described condition.

Note that, in the camera control section 206, the magnification factor of the camera 101 and the magnification factor of the camera 102 may be controlled separately. Note that, when the relationship in magnification factor between the camera 101 and the camera 102 is reversed, wide-angle video which is output to the zoom region information adding section 501 (described below) needs to be switched from the video of the camera 101 to the video of the camera 102.

The zoom region information adding section 501 produces a frame to be superposed on the wide-angle video, based on the magnification factor information about the cameras 101 and 102 obtained from the camera control section 206. Also, the zoom region information adding section 501 superposes the produced frame on the wide-angle video held by the frame buffer 104 and outputs the result to the selector 503. Sizes of the frame to be superposed on the wide-angle video are obtained by the following expressions:

(a size correction coefficient)=(the magnification factor of the wide-angle shooting camera)/(the magnification factor of the zoom shooting camera);

(a size in the horizontal direction of the frame)=(the size correction coefficient)*(a size in the horizontal direction of the wide-angle video); and

(a size in the vertical direction of the frame)=(the size correction coefficient)*(a size in the vertical direction of the wide-angle video).

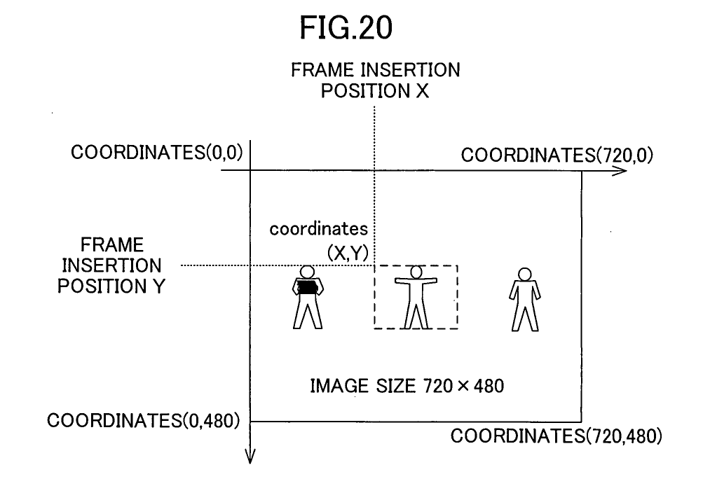

FIG. 20 is a diagram for describing a process of superposing the frame on the wide-angle video. In FIG. 20, an insertion position X and an insertion position Y of the frame are obtained by:

(the frame insertion position X)=((the size in the horizontal direction of the wide-angle video)−(the size in the horizontal direction of the frame))/2; and

(the frame insertion position Y)=((the size in the vertical direction of the wide-angle video)−(the size in the vertical direction of the frame))/2.

The monitor video switching control section 504 switches the selector 503 in accordance with a user's request to select video to be output to a monitor 506.

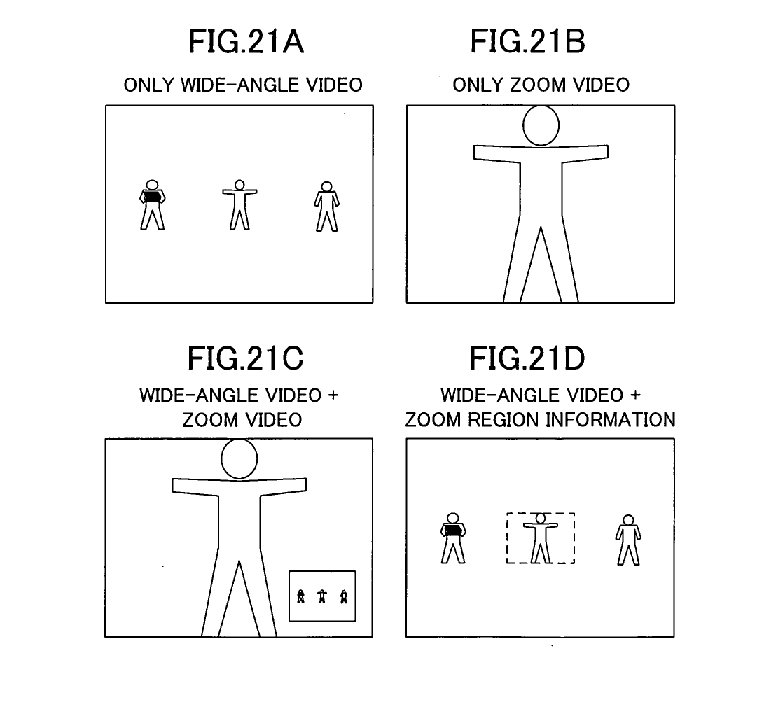

FIGS. 21A to 21D are diagrams for describing pieces of video which can be switched by the selector 503 of FIG. 19. FIG. 21A is a diagram for describing wide-angle video held by the frame buffer 104 of FIG. 19. FIG. 21B is a diagram for describing zoom video held by the frame buffer 105 of FIG. 19. FIG. 21C is a diagram for describing video which is obtained by the combining section 502 of FIG. 19 superposing the zoom video held by the frame buffer 104 and the wide-angle video held by the frame buffer 105. FIG. 21D is a diagram for describing video which is obtained by the zoom region information adding section 501 of FIG. 19 superposing the wide-angle video and a frame.

As described above, when multiangle shooting is performed in the same direction from the same position, a relative relationship between wide-angle video and zoom video can be obtained from magnification factor information about two shooting cameras, and the relationship is displayed in the wide-angle video using a frame, thereby making it possible to easily confirm the zoom region while viewing the wide-angle video during recording.

### Sixth Embodiment

In a sixth embodiment, a method of detecting a deviation in position and shooting direction between two cameras, and automatically switching to two-screen display of video displayed on a monitor, will be described.

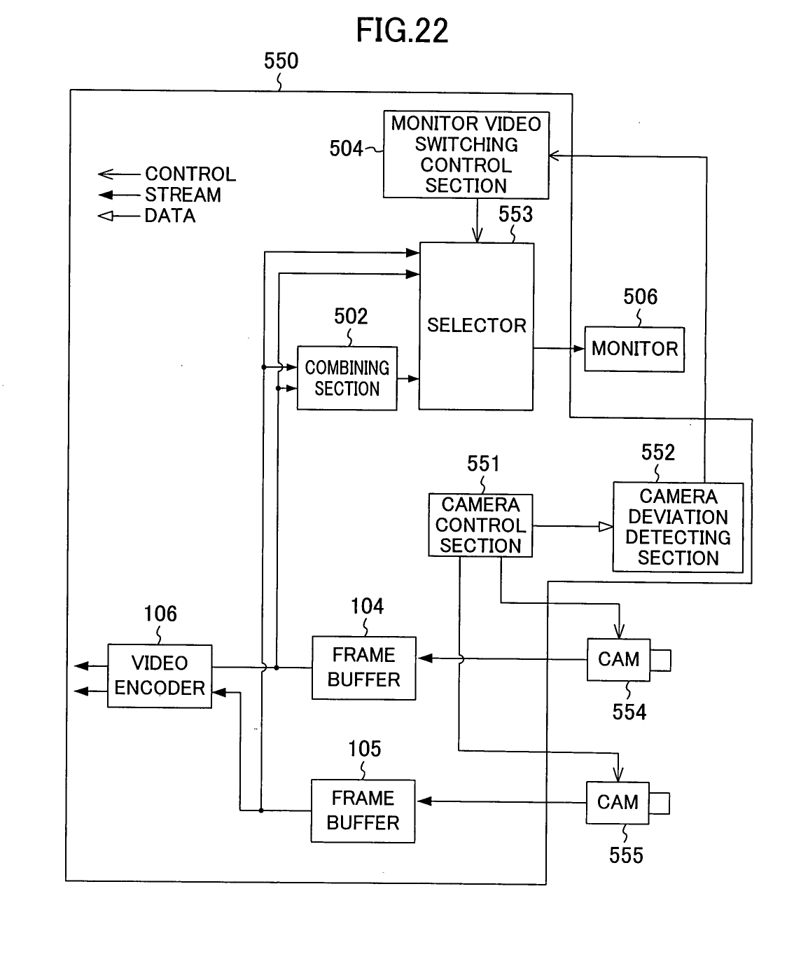

FIG. 22 is a block diagram showing a configuration of a stream encoder according to the sixth embodiment of the present invention. The stream encoder 550 of FIG. 22 is different from the stream encoder 200 of FIG. 8 in that a camera control section 551 and a camera deviation detecting section 552 are provided instead of the camera control section 206 and the overlapping video converting section 201, respectively, and a combining section 502, a selector 553, and a monitor video switching control section 504 are further provided. In FIG. 22, the audio encoder 107, the video buffers 108 and 109, the audio buffer 110, the encoder control section 111, the system encoder 112, the stream buffer 114, and the navigation information producing section 202 are not shown.

Hereinafter, an operation of the whole stream encoder 550 will be described with reference to FIG. 22.

A camera 554 and a camera 555 can be horizontally rotated by a user's request. The camera control section 551 controls the horizontal rotation of the camera 554 and the camera 555, and manages angle information about the camera 554 and the camera 555. Note that the camera 554 and the camera 555 may be rotated vertically as well as horizontally. Also, the camera 554 and the camera 555 may be detachably attached to the main body of an apparatus. Note that the camera control section 551 needs to supervise the attached or detached state of the camera 554 and the camera 555.

The camera deviation detecting section 552 detects a deviation in position and shooting direction between the camera 554 and the camera 555 based on the angle information (attachment/detachment information) about the camera 554 and the camera 555 which is obtained from the camera control section 551. When a deviation in position or shooting direction between the camera 554 and the camera 555 has been detected, the selector 553 is notified of the camera deviation.

The selector 553, when being notified of the camera deviation, selects and outputs video which is obtained by the combining section 502 superposing wide-angle video held by the frame buffer 104 and zoom video held by the frame buffer 105 (FIG. 21C) to the monitor 506.

Note that, as shown in FIG. 21C, it is not necessary to display the zoom video on the entire screen and display the wide-angle video in a lower right portion of the screen. Alternatively, the two pieces of display video may be provided at any positions and in any sizes as long as the two pieces of video are displayed within a single screen.

As described above, when a deviation occurs in position and shooting direction between two cameras during multiangle shooting in the same direction from the same position, a monitoring method is automatically switched to two-screen display, thereby making it possible to eliminate a task of switching settings of monitor display during recording.

### Seventh Embodiment

In the third embodiment, an overlapping portion of input video of two cameras is determined based on the relationship between the shooting magnification factors of the two cameras, and the overlapping portion of one of the two cameras is replaced with data having a high compression factor (e.g., a single-color, still-image data), thereby reducing the processing load during encoding. In a seventh embodiment, a resource of the encoder which is acquired by reducing the load in the third embodiment is utilized for encoding of main video (e.g., video captured at a high magnification factor), thereby recording main video with high image quality.

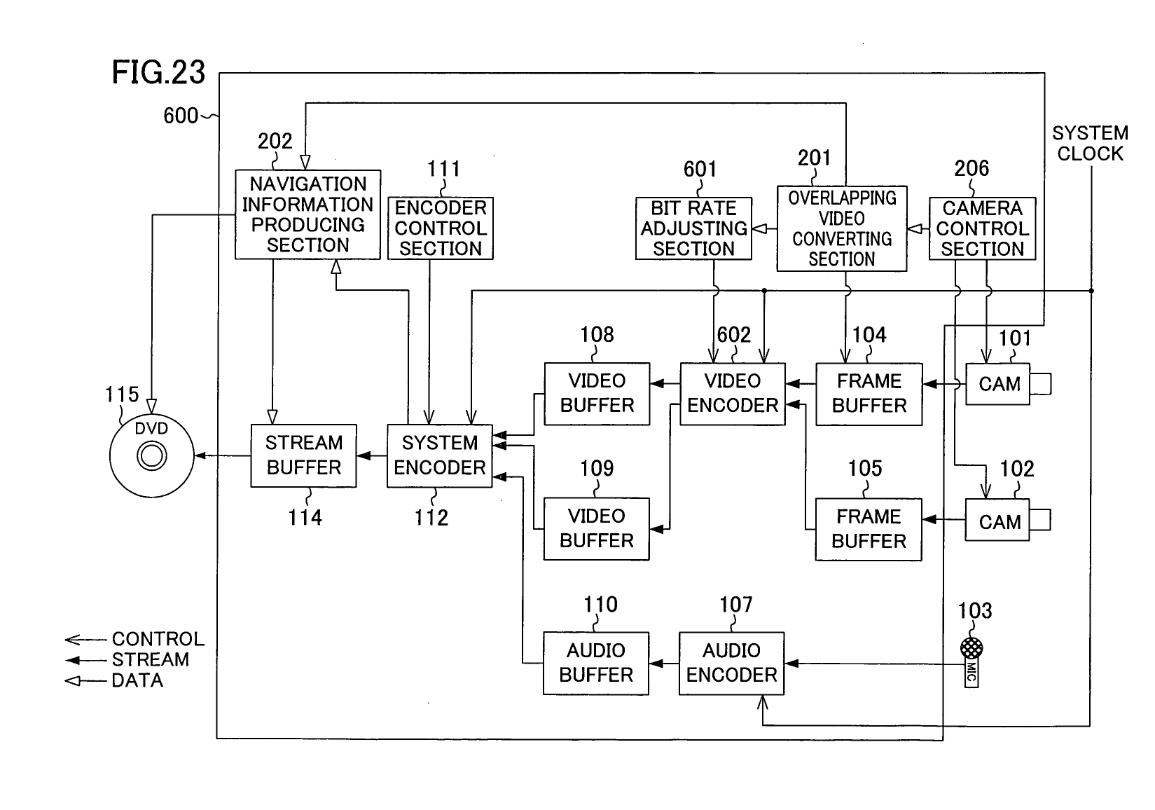

FIG. 23 is a block diagram showing a configuration of a stream encoder according to the seventh embodiment of the present invention. The stream encoder 600 of FIG. 23 is different from the stream encoder 200 of FIG. 8 in that a video encoder 602 is provided instead of the video encoder 106, and a bit rate adjusting section 601 is further provided. The video encoder 602 is obtained by adding to the video encoder 106 of FIG. 8 a function of changing a bit rate, depending on the angle.

Hereinafter, an operation which effectively utilizes a resource of the encoder will be described with reference to FIG. 23.

The bit rate adjusting section 601 manages a bit rate at which data held by the frame buffers 104 and 105 is encoded. The bit rate adjusting section 601 obtains a size of the overlapping region from the overlapping video converting section 201 so as to determine a bit rate at which data in the frame buffer 104 is encoded. The obtained overlapping region size is utilized so as to obtain the proportion of the overlapping region to a screen of video. The proportion of the overlapping region to a single screen is represented by:

(the bit rate at which data in the frame buffer 104 is encoded)=(a bit rate in the absence of an overlapping region)*(1−(the proportion of the overlapping region))+α.

Thus, the bit rate at which data in the frame buffer 104 is encoded is determined.

Note that α is a value which is determined in view of the load of a process when mono-color data replacing the overlapping region is encoded, and may be considered to be zero if the video encoder has a margin of load.

The bit rate adjusting section 601 notifies the video encoder 602 of the bit rate obtained by the above-described expression as a bit rate for encoding data in the frame buffer 104. Also, the bit rate adjusting section 601 determines a bit rate at which encoding data in the frame buffer 105 by:

(the bit rate at which data in the frame buffer 105 is encoded)=(a bit rate in the absence of an overlapping region)*(1+(the proportion of the overlapping region))−α.

Therefore, a bit rate which is subtracted when data in the frame buffer 104 is encoded is added to the bit rate at which data in the frame buffer 105 is encoded. The bit rate adjusting section 601 notifies the video encoder 602 of the bit rate obtained by the above-described expression as a bit rate for encoding data in the frame buffer 105.

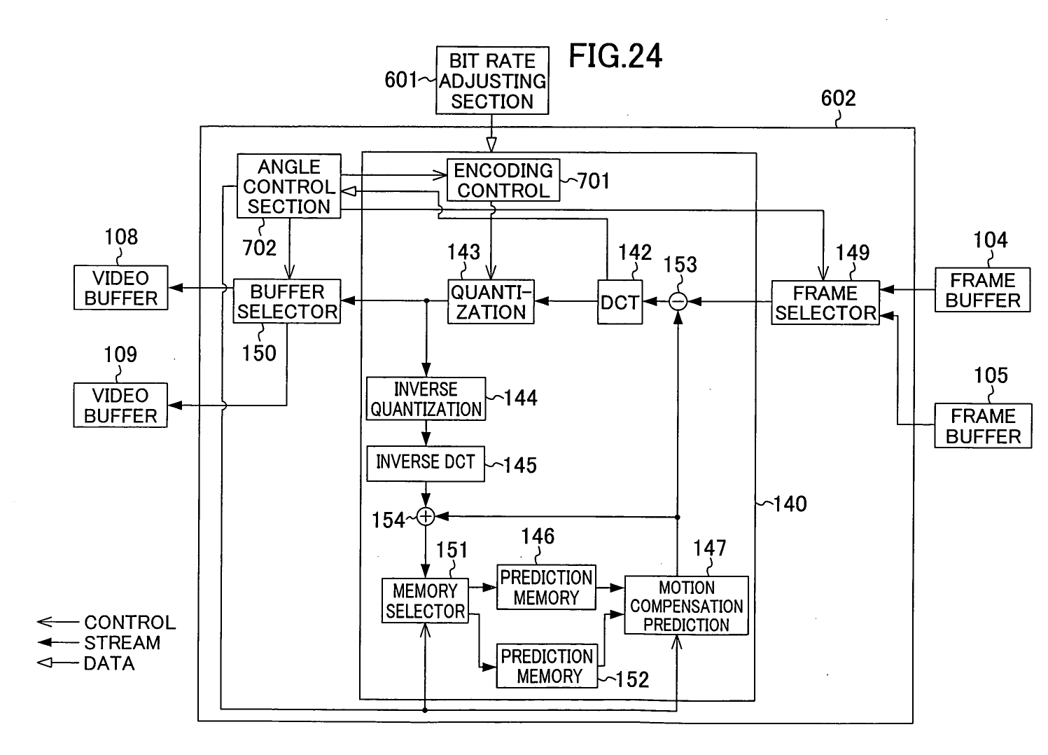

FIG. 24 is a block diagram showing a configuration of the video encoder 602 according to the seventh embodiment of the present invention. The video encoder 602 of FIG. 24 is different from the video encoder 106 of FIG. 3 in that an encoding control section 701 and an angle control section 702 are provided instead of the encoding control section 141 and the angle control section 148, respectively.

Hereinafter, an internal process of the video encoder 602 will be described with reference to FIG. 24.

The video encoder 602 receives bit rate information about data held by the frame buffer 104 and bit rate information about data held by the frame buffer 105 from the bit rate adjusting section 601 of FIG. 23. The encoding control section 701 holds these pieces of bit rate information thus received.

The angle control section 702 is obtained by adding to the angle control section 148 of FIG. 2 a function of notifying the encoding control section 701 of timing of switching angles to be encoded. The encoding control section 701 receives the angle switching timing from the angle control section 702, and controls each block so that encoding is performed at a bit rate suited to each angle.

As described above, in this embodiment, there is an overlapping region of two pieces of video, and the overlapping region of one of the two pieces of video is replaced with mono-color data, so that the load of an encoding process is reduced. In this case, a stream encoder assigns an encoder resource acquired by reducing the load to encoding of main video (video in which the overlapping region is not replaced with mono-color data), thereby making it possible to perform recording with higher image quality.

As described above, the present invention can encode and combine a plurality of pieces of video in real time to generate a single stream, and therefore, is useful for, for example, a recording device supporting a multiangle function, such as a DVD camcorder, a DVD recorder or the like.

What is claimed is:

1. A stream encoder comprising:
a video encoder for receiving and encoding first and second angle video data, and outputting the results as first and second encoded video data;
a first video buffer for storing the first encoded video data; and
a second video buffer for storing the second encoded video data,
wherein the video encoder comprises:
a first angle control section for outputting a first angle control signal for controlling switching to be performed every time when encoding of one frame of the first or second angle video data is completed;
a frame selector for selecting and outputting the first or second angle video data in accordance with the first angle control signal;
a motion compensation prediction encoder for encoding an output of the frame selector, and outputting the result as the first or second encoded video data; and
a buffer selector for outputting the first encoded video data to the first video buffer and the second encoded video data to the second video buffer in accordance with the first angle control signal, and
the motion compensation prediction encoder comprises:
a first prediction memory;
a second prediction memory;
a memory selector for outputting reference images for the first and second angle video data to the first and second prediction memories, respectively, in accordance with the first angle control signal;
a motion compensation prediction section for performing a motion compensation prediction process using a reference image stored in any one of the first prediction memory and the second prediction memory in accordance with the first angle control signal,
wherein the motion compensation prediction encoder can encode two or more frames per frame cycle of the first or second angle video data.

2. The stream encoder of claim 1, further comprising:
a system encoder for producing and outputting a stream from the first and second encoded video data and encoded audio data common to the first and second encoded video data,
wherein the system encoder comprises:
a video selector for selecting and outputting the first encoded video data or the second encoded video data from the first video buffer or the second video buffer in accordance with a second angle control signal;
a second angle control section for outputting as the second angle control signal a signal for controlling switching to be performed every time when the number of video frames of the encoded video data selected by the video selector reaches a predetermined frame number;
a video packet generating section for generating and outputting a video packet header from the received first encoded video data or second encoded video data;
an audio packet generating section for generating and outputting an audio packet from the encoded audio data when the first encoded video data is selected in accordance with the second angle control signal;
an audio packet holding section for storing the audio packet; and
an audio selector for selecting and outputting the audio packet output from the audio packet generating section when the first encoded video data is selected in accordance with the second angle control signal, and the audio packet held by the audio packet holding section when the second encoded video data is selected in accordance with the second angle control signal,
wherein the system encoder can encode two or more frames of the first or second encoded video data per frame cycle of the first or second angle video data.

3. The stream encoder of claim 2, wherein
the system encoder further comprises:
a video packet header holding section for storing the video packet header, and
the video packet generating section generates and outputs the video packet header or reads and outputs the video packet header from the video packet header holding section, in accordance with the second angle control signal.

4. The stream encoder of claim 1, further comprising:
a camera control section for controlling shooting magnification factors of a first camera for outputting the first angle video data and a second camera for shooting in the same direction as that of the first camera and outputting the second angle video data, and outputting shooting magnification factor information indicating the shooting magnification factors of the first and second cameras; and
an overlapping video converting section for calculating a portion of video captured by one of the first and second cameras having a smaller shooting magnification factor, the portion overlapping video captured by the other camera, based on the shooting magnification factor information, and converting the overlapping portion into video having a small load in an encoding process.

5. The stream encoder of claim 4, further comprising:
a magnification factor detection compensating section for outputting to the camera control section a signal for adjusting the shooting magnification factors of the first and second cameras so that a boundary of the overlapping portion coincides with a boundary of a macroblock for encoding, based on the shooting magnification factor information received from the camera control section.

6. The stream encoder of claim 4, further comprising:
a bit rate adjusting section for obtaining and outputting, as bit rate information, bit rates at which the pieces of video captured by the first and second cameras are encoded, depending on a proportion of the portion overlapping video captured by the other camera to the video captured by one of the first and second cameras having the shooting magnification factor lower than that of the other,
wherein the video encoder further comprises:
an encoding control section for adjusting the bit rates at which the first and second angle video data are encoded, based on the first angle control signal and the bit rate information.

7. The stream encoder of claim 1, further comprising:
a camera control section for controlling shooting magnification factors of a first camera for outputting the first angle video data and a second camera for shooting in the same direction as that of the first camera and outputting the second angle video data, and outputting shooting magnification factor information indicating the shooting magnification factors of the first and second cameras; and
a zoom region information adding section for calculating a portion of video captured by one of the first and second cameras having a smaller shooting magnification factor, the portion overlapping video captured by the other camera, based on the shooting magnification factor information, and combining and outputting a display indicating a range of the video captured by the other camera with the video captured by the one camera having the smaller shooting magnification factor.

8. The stream encoder of claim 1, further comprising:
a camera control section for controlling shooting magnification factors of a first camera for outputting the first angle video data and a second camera for shooting in the same direction as that of the first camera and outputting the second angle video data, and outputting shooting direction information indicating shooting directions of the first and second cameras; and
a camera deviation detecting section for detecting a change in positions and shooting directions of the first and second cameras based on the shooting direction information, and when a change in any of the position and the shooting direction is detected, outputting a signal for controlling to simultaneously display pieces of video of the first and second angle video data.

9. A stream decoder comprising:
a data reading section for reading and outputting stream data including first encoded video data, and second encoded video data obtained by shooting in the same direction as a direction in which the first encoded video data is captured and with a magnification factor higher than that of the first encoded video data;
a data transferring section for receiving the stream data output by the data reading section, separating the stream data into the first and second encoded video data, and outputting the first and second encoded video data;
a first decoder for decoding the first encoded video data and outputting first video data;
a second decoder for decoding the second encoded video data and outputting second video data;
a resizing process section for converting the second video data into video data having a size of a portion overlapping video of the first video data and outputting the resultant video data; and
a combining section for superposing and combining the video after the conversion in the resizing process section with the portion overlapping the video of the first video data, and outputting the resultant video data.
